(19) United States
(12) Patent Application Publication
(10) Pub. No.: US 2015/0201632 A1
(43) Pub. Date: Jul. 23, 2015

(54) Food smoker chimney weather guard

(71) Applicants: Allen Ferber, Fernandina Beach, FL (US); John Piscetta, Mableton, GA (US)

(72) Inventors: Allen Ferber, Fernandina Beach, FL (US); John Piscetta, Mableton, GA (US)

(21) Appl. No.: 14/544,179

(22) Filed: Dec. 6, 2014

Related U.S. Application Data
(60) Provisional application No. 61/963,575, filed on Dec. 9, 2013.

(51) Int. Cl. A23B 4/052; F23L 17/02

(52) U.S. Cl. CPC A23B 4/052; F23L 17/02

(57) ABSTRACT

A hood like metal device that is formed to provide protection for various commercially available “backyard” kamado style food smokers from precipitation intrusion. An opening (12) in the flat base part of the unit (14) can be sized to fit over the chimney (15) of various food smokers (16). The air flow and temperature regulating device (17) of the smoker holds the unit firmly in place and functions normally without interference from the unit.

### CROSS-REFERENCE TO RELATED APPLICATIONS: PPA 61963575

### FEDERALLY SPONCERED RESEARCH: None

### SEQUENCE LISTING: None

### BACKGROUND

This relates to protecting the food in a commercial available backyard food smoker from precipitation intrusion while using the smoker in an open air situation. Many food smokers of the kamado style, have a chimney at the top that is fitted with a devise to control air flow and therefore temperature in the smoker. To do this, an adjustable opening in the top of the air flow and temperature regulating device is exposed to the elements and precipitation can enter the smoker. Precipitation entering the smoker accumulates on the food being smoked, cools the fire, and generally interferes with the smoking process.

In conclusion, a device that is easy to use, requires no modification to the smoker and shelters the smoker chimney from all precipitation intrusion is needed. The Food Smoker Chimney Weather Guard (subsequently referred to as the “Weather Guard”) does this in a very simple and effective way. Using the smoker during inclement weather when many hours of smoking are required can be conducted without concern for water intrusion with the Weather Guard installed. The following description and accompanying drawings will further enhance the understanding and advantages of this device.

### DRAWINGS

FIG. 1A is a perspective front on end view of the Weather Guard standing alone before being installed on a commercially available kamado style backyard smoker.

FIG. 1B is a perspective front on end view of the Weather Guard of FIG. 1A placed over the chimney of a commercially available backyard smoker.

FIG. 1C is a perspective front on end view of the Weather Guard placed over the chimney (which is not visible) with the addition of the air flow and temperature regulating device of a commercially available backyard smoker. This device 17 is used to hold the Weather Guard in place.

FIG. 2 is a perspective bottom view of the Weather Guard standing alone and depicting the circular opening that fits over the smoker chimney.

### DETAILED DESCRIPTION

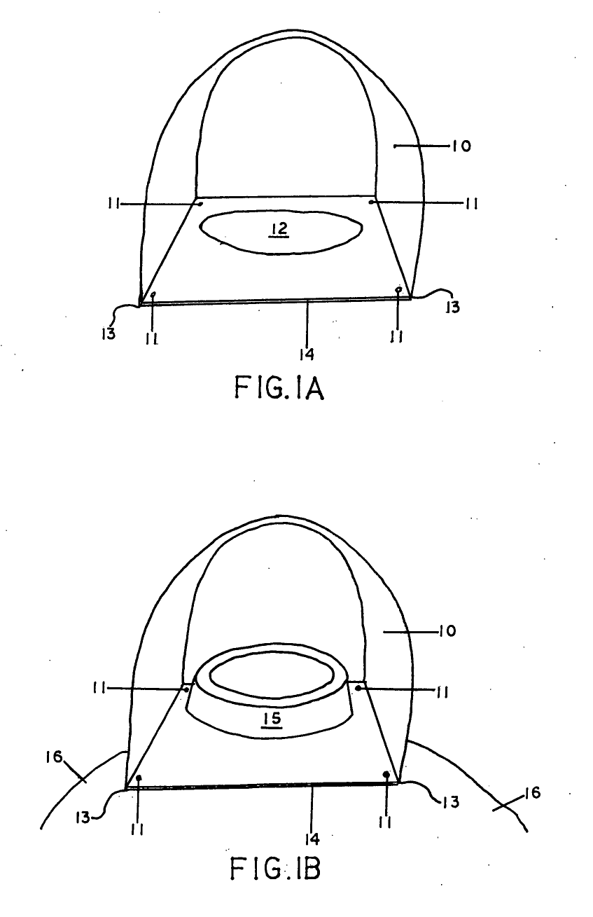

FIG. 1A is a perspective front on end view of the Weather Guard standing alone before being installed on a commercially available backyard smoker. The Weather Guard is constructed by taking a single rectangular sheet of light gauge aluminum sheeting 10 and machining two same sized openings 12 at opposite ends. These openings can be sized to fit a variety of smokers. Each end of the aluminum sheet is break formed at ninety degrees. This break location is measured from the edge a distance equal to the width of the bottom section. This forms the bottom of the Weather Guard 14 by overlapping each side to form a double layer of the aluminum material. The two layers are spot welded or riveted 11 together to form the whole unit.

FIG. 1B is a perspective front on end view of the Weather Guard of FIG. 1A, placed over the chimney 15 of a commercially available backyard kamado style smoker 16. The Weather Guard opening 12 fits snugly over the smoker chimney 15.

FIG. 1C is a perspective front on end view of the Weather Guard placed over a chimney 15 (which is hidden from view) with the addition of an air flow and temperature regulating device 17 (depicted as generic) of a commercially available backyard smoker 16. This device 17 is usually a heavy cast iron assembly and for this application is also used to hold the Weather Guard in place on the smoker chimney. Some differences in the way various smokers are configured, may require the removal of a set screw to remove the device 17. (not depicted in this Fig.) The adjustable openings 18 in the top of the device 17 allow air to flow out and precipitation, rain, snow, and sleet into the food smoking area if the smoker is used in an open air setting.

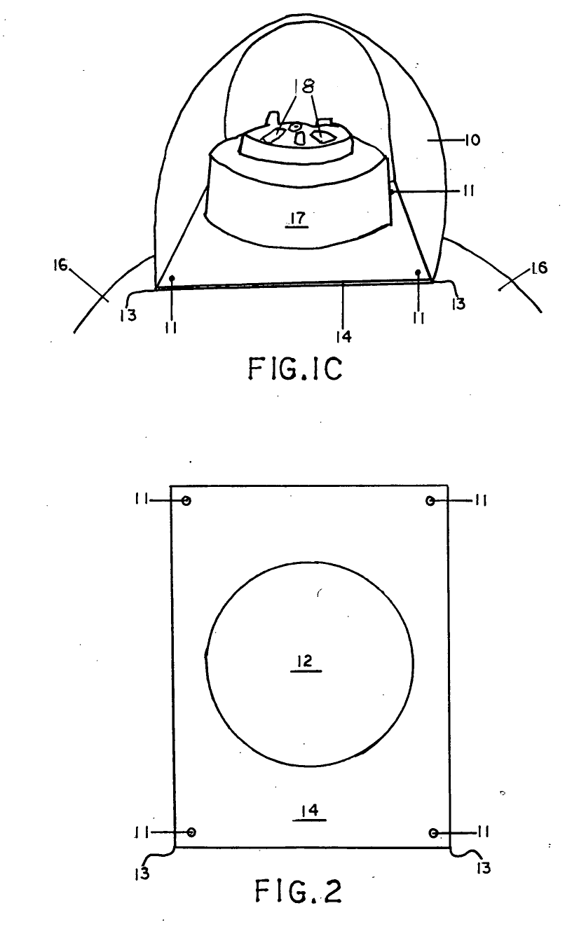

FIG. 2 is a perspective bottom view of the Weather Guard standing alone and depicting the circular opening 12 that fits over the smoker chimney. This opening 12 can be sized to fit different commercially available backyard smokers. The unit bottom, FIG. 2, is a double layer of the aluminum sheeting 14 that is fastened together by spot welds or rivets 11. This double layer 14 that forms the bottom of the Weather Guard adds strength and rigidity to the whole unit.

### REFERENCE NUMERALS

10 light gauge aluminum sheeting

11 spot welds or rivets

12 opening sized for the chimney of a commercially available food smoker

13 ninety degree break form/bend of the aluminum sheeting

14 double layer of aluminum sheeting comprising the bottom of the unit

15 smoker chimney

16 commercially available kamado style food smoker

17 air flow and temperature regulating device of a commercially available kamado style food smoker

18 adjustable openings on the air flow and temperature regulating device

Operation:

In operation one uses the Weather Guard as an accessary to a commercially available backyard kamado style food smoker 16. While using the smoker in an open air setting and precipitation is present or predicted, the Weather Guard is placed on the smoker chimney. To install the Weather Guard, one first removes the air flow and temperature regulating device 17 that sits on the smoker chimney. The Weather Guard is then placed over the chimney. Once this is done, the regulating device 17 (which is usually a heavy iron casting) is replaced on the chimney. The weight of this device holds the Weather Guard in place on the smoker chimney 15. Some differences in the way various smokers are configured may require the removal of a set screw to remove the device 17. The Weather Guard provides a cover that prevents precipitation from entering the smoker food area through the openings 18 in the regulating device 17 located on the chimney 15 at the top of the smoker 16.

1. a single sheet of light gauge metal that is machined, bent and folded to form a hood like structure and then fastened together to hold the shape and

2. a flat lower surface or base that has an opening sized to fit over smoker chimneys and

3. a sufficient coverage of the smoker chimney to keep precipitation from entering the cooking area of the smoker
Whereby (a) operation of a smoker in an open air setting during periods of precipitation, the operator can easily place the Weather Guard on the smoker chimney, (b) the Weather Guard will prevent precipitation from entering the food smoking area, (c) the Weather Guard will stay in place even in high wind conditions and (d) will not interfere with normal operation of the smoker, (e) the Weather Guard will withstand all normal environmental conditions and normal smoker temperatures.
